(19) United States
(12) Patent Application Publication
(10) Pub. No.: US 2015/0220384 A1
(43) Pub. Date: Aug. 6, 2015

(54) INFORMATION PROCESSING APPARATUS, INFORMATION PROCESSING SYSTEM, AND FAILURE DETECTION METHOD

(71) Applicant: FUJITSU LIMITED, Kawasaki-shi (JP)

(72) Inventor: Kazuyoshi MIYAZAWA, Kunitachi (JP)

(21) Appl. No.: 14/566,758

(22) Filed: Dec. 11, 2014

(30) Foreign Application Priority Data
Feb. 4, 2014 (JP) 2014-019455

(51) Int. Cl. G06F 11/10

(52) U.S. Cl. CPC G06F 11/1004

(57) ABSTRACT

An information processing apparatus includes a first transfer unit that receives data and transfers the data to a second transfer unit per a predetermined unit of transfer; and the second transfer unit that sends the data that is received from the first transfer unit, wherein the first transfer unit includes: a first calculator that calculates first error information on the whole received data on the basis of the received data; a second calculator that calculates, on the basis of the data that is sent by the second transfer unit, second error information on the whole sent data; and an error detector that compares the first error information and the second error information to detect an error.

### CROSS-REFERENCE TO RELATED APPLICATION

This application is based upon and claims the benefit of priority of the prior Japanese Patent Application No. 2014-019455, filed on Feb. 4, 2014, the entire contents of which are incorporated herein by reference.

### FIELD

The embodiments discussed herein are directed to an information processing apparatus, an information processing system, and a failure detection method.

### BACKGROUND

In a data transfer control circuit in an apparatus, a longitudinal parity or check and collection (ECC) check code for checking data per unit of processing is used in many cases. One unit of processing will be referred to as a “word” below. On the other hand, in a storage media, such as an interface between serial transmission devices or a hard disk, a vertical cyclic redundancy check (CRC) check code for checking data over multiple words is used in many cases.

For example, methods of checking data that is sequentially transmitted through an input output (IO) device, a channel device, a system control device, and a main storage device, which are methods that are performed in the IO device, the channel device, the system control device, and the main storage device, respectively, will be described below. The channel device is a device that transfers data to a corresponding IO device per channel. The system control device is a device that transfers data transmitted from the channel device to the central processing unit (CPU) and the main storage device.

Upon receiving data from the IO device, the channel device checks the data using CRC. The channel device checks data to be transmitted from the channel device to the system control device, using parity or ECC. Thereafter, upon receiving the data from the channel device, the system control device checks the data using CRC. The system control device further checks data to be transmitted from the system control device to the main storage unit, using parity or ECC.

In such data transfer in an information processing apparatus, a check for a failure using parity or ECC involves an error per byte or per word that is difficult to detect depending on the site of failure.

For example, a parity is calculated by summing values in a byte and is, like a parity 902 illustrated in FIG. 12, added per byte to perform an error check. FIG. 12 illustrates that each error detection code is added to data. An error of two or more bits is not detected using parity.

An ECC is a value that is calculated using the parity and that is, like an ECC 902 illustrated in FIG. 12, added to one word including multiple bytes. When one bit is an erroneous value, an error is corrected by ECC and, when two or more bits are erroneous values, it is detected by ECC that an error that is not corrected has occurred.

On the other hand, a CRC is calculated by applying a polynomial to packets and is, like a CRC 903 illustrated in FIG. 12, added per packet to perform an error check.

A check sum is, like a check sum 904 illustrated in FIG. 12, a value that is calculated by performing operations across multiple packets and is used to perform an error check.

Using a CRC or check sum, error detection can be performed per byte or per word.

For example, for the data transfer descried above, the channel device and the system control device store data in a random access memory (RAM) and read data from the RAM. If an error occurs in a set signal and a reset signal that are input or a clock input signal in each register, an error per byte occurs. If an error occurs in a write enable signal to the RAM when data is written in the RAM from each register and when data is read from the RAM to each register, an error per byte occurs. In such a case, it is difficult to detect the error using parity or ECC.

There is a conventional technology where a parity is added per word to data to be transferred and a check sum is added per frame to data to be transferred in order to detect an error that is difficult to detect due to a parity or ECC error.

Patent Document 1: Japanese Laid-open Patent Publication No. 2000-36805

If the conventional technology where a check sum is added is used, data added with a check sum is transferred, which lowers the transfer efficiency.

### SUMMARY

According to an aspect of an embodiment, an information processing apparatus includes: a first transfer unit that receives data and transfers the data to a second transfer unit per a predetermined unit of transfer; and the second transfer unit that sends the data that is received from the first transfer unit, wherein the first transfer unit includes: a first calculator that calculates first error information on the whole received data on the basis of the received data; a second calculator that calculates, on the basis of the data that is sent by the second transfer unit, second error information on the whole sent data; and an error detector that compares the first error information and the second error information to detect an error.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a system configuration diagram of an information processing apparatus;

FIG. 2 is a block diagram of a system control device and a channel device;

FIG. 3 is a configuration diagram of an overview of the hardware of the system control device and the channel device;

FIG. 4 illustrates exemplary division of data to be transmitted from an IO device to a main storage device;

FIG. 5 illustrates exemplary division of a system control device per-packet check sum to be transmitted from the system control device to the channel device;

FIG. 6 is a timing chart of operations performed by each unit to perform data transfer;

FIG. 7 is a flowchart of operations performed by the channel device to receive data from the IO device;

FIG. 8 is a flowchart of operations performed by the channel device to transmit data to the system control device;

FIG. 9 is a flowchart of operations performed by the system control device to receive data from the channel device;

FIG. 10 is a flowchart of operations performed by the system control device to transmit a check sum to the channel device;

FIG. 11 is a flowchart of operations performed by the channel device to receive a check sum from the system control device; and

FIG. 12 illustrates states where each error detection code is added to data.

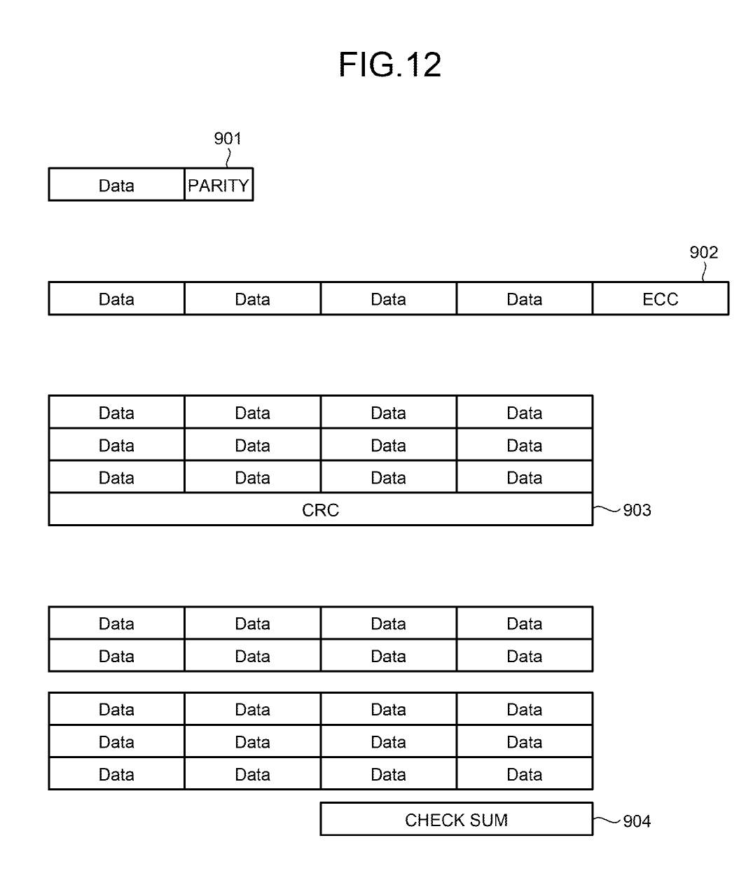

### DESCRIPTION OF EMBODIMENT

Preferred embodiments of the present invention will be explained with reference to accompanying drawings. The following embodiments do not limit the information processing apparatus, the information processing system, and the failure detection method disclosed herein.

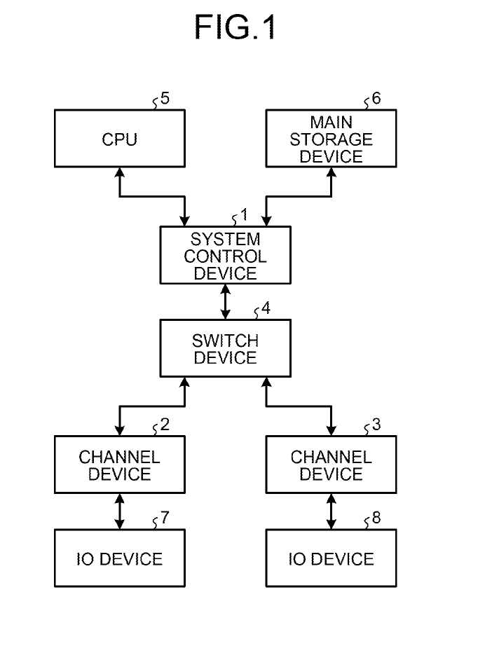

FIG. 1 is a system configuration diagram of an information processing apparatus. An information processing apparatus according to an embodiment includes a system control device 1, channel devices 2 and 3, a switch device 4, a CPU 5, a main storage device 6, and IO devices 7 and 8.

The CPU 5 is an operation unit that performs operations using the data stored in the main storage device 6, etc.

The main storage device 6 is, for example, a memory that stores data to be used by the CPU 5 for operations, etc.

The IO devices 7 and 8 are devices that manage data and that output data that is stored and store data that is input. For example, each of the IO devices 7 and 8 is a device that stores data, such as a hard disk. The IO device 7 accepts a read instruction from the channel device 2 and transmits the data stored therein to the channel device 2. The IO device 7 stores data that is output from the channel device 2 in the main storage device 6.

The channel devices 2 and 3 are arranged on the respective channels that are data transmission routes. Each of the channel devices 2 and 3 controls data transfer via a corresponding channel where the corresponding one of the channel device 2 and the channel device 3 is arranged. FIG. 1 illustrates an exemplary information processing apparatus including two channels; however, the information processing apparatus may include any number of channels. FIG. 1 illustrates the two channel devices 2 and 3, i.e., channel devices are arranged according to the number of channels. The channel devices 2 and 3 have the same function for the channels in which the channel devices 2 and 3 are arranged, and the channel device 2 will be described exemplarily below.

For example, the channel device 2 transmits data that is input from the IO device 7 to the main storage device 6 via the switch device 4 and the system control device 1. The channel device 2 also receives data that is read from the main storage device 6 via the system control device 1 and the switch device 4 and transmits the data to the IO device 7. The channel device 2 serves as an example of a “first transfer unit” and a “first data transfer device”.

The switch device 4 controls a data transfer route between the channel device 2 and the system control device 1. The switch device 4 outputs data that is input from the channel device 2 to the system control device 1. The switch device 4 also outputs data that is input from the system control device 1 to the channel device 2 that is specified by the system control device 1.

Upon accepting an instruction from the CPU 5, the system control device 1 reads data from the main storage device 6 and transmits, via the switch device 4, the data to the channel device 3 that is specified by the CPU 5. Upon accepting an instruction from the CPU 5, the system control device 1 issues a data read instruction to the channel device 2. The system control device 1 receives data from the channel device 2 via the switch device 4 and stores the data in the main storage device 6. The system control device 1 serves as an example of a “second transfer unit” and a “second data transfer device”.

A whole flow from reading of data from the IO device 7 to storing of the data in the main storage device 6 will be collectively described here. The channel device 2 reads data that is specified by the CPU 5 from the IO device 7. The channel device 2 transmits the read data to the system control device 1 via the switch device 4. The system control device 1 receives the data output by the channel device 2 via the switch device 4. The system control device 1 stores the received data in an address of the main storage device 6 that is specified by the CPU 5.

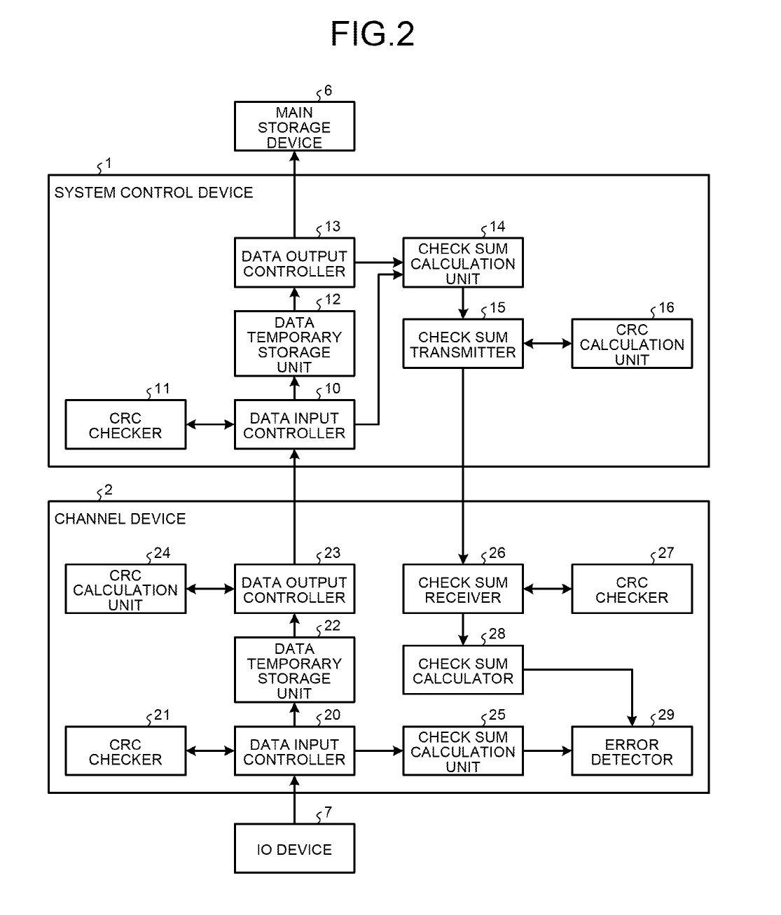

Data transfer between the system control device 1 and the channel device 2 will be described in detail below with reference to FIG. 2. FIG. 2 is a block diagram of the system control device and the channel device. The switch device 4 only mediates data transfer between the system control device 1 and the channel device 2 and thus is not illustrated in FIG. 2.

The channel device 2 includes a data input controller 20, a CRC checker 21, a data temporary storage unit 22, a data output controller 23, and a CRC calculation unit 24. The channel device 2 further includes a check sum calculation unit 25, a check sum receiver 26, a CRC checker 27, a check sum calculator 28, and an error detector 29.

The IO device 7 divides the data into packets and transmits the data packets. The IO device 7 adds a CRC check code to each of the divided packets.

The data input controller 20 receives a packet added with a CRC check code from the IO device 7. The data input controller 20 then outputs the received packed to the CRC checker 21 and then receives the check result from the CRC checker 21.

The data input controller 20 adds an ECC check code to each set of data and then outputs the data to the data temporary storage unit 22. At the same time, the data input controller 20 outputs the data to the check sum calculation unit 25.

The CRC checker 21 receives, from the data input controller 20, an input of the packet that is transmitted from the IO device 7 to the channel device 2. The CRC checker 21 calculates the CRC check code using the data contained in the received packet. The CRC checker 21 then compares the CRC check code added to the received packet with the calculated CRC check code and, if they match, determines that no error has occurred and, if they do not match, detects that an error has occurred.

The CRC checker 21 then outputs the CRC check result to the data input controller 20.

When transferring data to the system control device 1, the data temporary storage unit 22 temporarily stores the data in order to output the data according to the timing at which the the system control device 1 receives the data. The data temporary storage unit 22 is, for example, a memory.

The data temporary storage unit 22 receives the data added with the ECC check code from the data input controller 20 and stores the data. The data temporary storage unit 22 sequentially outputs the data according to the timing at which the system control device 1 receives the data.

The data output controller 23 receives, from the data temporary storage unit 22, an input of the data to be transmitted to the system control device 1. The data output controller 23 detects an error and corrects the error using the received data and the ECC. If nor any error that is not corrected is detected, the data output controller 23 proceeds the processing.

The data output controller 23 divides the received data into packets. The lengths of the packets may be, regardless of the packet length used by the IO device 7, the same or different from each other. The data output controller 23 outputs the generated packets to the CRC calculation unit 24. The data output controller 23 then receives a CRC check code from the CRC calculation unit 24. The data output controller 23 outputs the packets added with the CRC to the system control device 1.

The maximum length of the packets to be transmitted by the data output controller 23 to the system control device 1 serves as an example of a “predetermined unit of transfer”.

The CRC calculation unit 24 receives, from the data output controller 23, the packets to be transmitted to the system control device 1. The CRC calculation unit 24 then calculates a CRC check code on the basis of the value of the data contained in each packet. The CRC calculation unit 24 then outputs the calculated CRC check code to the data output controller 23.

The check sum calculation unit 25 receives the data, which is input from the IO device 7, from the data input controller 20. The check sum calculation unit 25 calculates a check sum of the whole received data. The whole data means all the data that is transmitted after the IO device 7 starts the data transfer and transmits the first packet until the channel meets a data transfer termination condition. The data transfer condition to be met by the channel is, for example, reception of a data transfer termination notification by the channel device 2. The check sum calculated by the check sum calculation unit 25 is referred to as a “channel device check sum”.

The check sum calculation unit 25 outputs the calculated channel device check sum to the error detector 29. The check sum calculation unit 25 serves as an example of a “first calculator”. The channel device check sum serves as an example of “first error information”.

The check sum receiver 26 receives, from a check sum transmitter 15 of the system control device 1 to be described below, a packet to be transmitted from the system control device 1 to the main storage device 6 that, which is a packet containing a check sum calculated per packet. The check sum calculated per packet to be transmitted from the system control device 1 to the main storage device 6 will be referred to as a “system control device per-packet check sum” below. The check sum receiver 26 outputs the received packet to the CRC checker 27. The check sum receiver 26 then receives the CRC check result from the CRC checker 27.

If no error has been detected according to the CRC check result, the check sum receiver 26 outputs the system control device per packet check sum to the check sum calculator 28.

The CRC checker 27 receives an input of the packet containing the system control device per-packet check sum from the check sum receiver 26. The CRC checker 27 then calculates a CRC check code using the data contained in the received packet. The CRC checker 27 then compares the CRC check code added to the received packet with the calculated CRC check code and, when they match, determines that no error has occurred and, when they do not match, detects that an error has occurred.

The CRC checker 27 then outputs the CRC check result to the check sum receiver 26.

The check sum calculator 28 receives, from the check sum receiver 26, an input of the system control device per-packet check sum. The check sum calculator 28 waits until reception of each check sum of all the packets corresponding to the whole data completes. The check sum receiver 26 performs operations using all the system control device per-packet check sums to calculate a check sum of the whole data.

The check sum of the whole data calculated by the check sum calculator 28 corresponds to the check sum of the whole data that is output by the system control device 1 to the main storage device 6. The check sum calculated by the check sum calculator 28 is referred to as a “system control device check sum” below.

The check sum calculator 28 then outputs the calculated system control device check sum to the error detector 29. The check sum calculator 28 serves as an example of a “second calculator”. The system control device check sum servers as an example of “second error information”.

The error detector 29 receives an input of the channel device check sum from the check sum calculation unit 25. The error detector 29 receives an input of the system control device check sum from the check sum calculator 28. The error detector 29 then compares the channel device check sum and the system control device check sum.

The channel device check sum is the check sum of the whole data received by the channel device 2 from the IO device 7. The system control device check sum is the check sum of the whole data that is output by the system control device 1 to the main storage device 6, which is the data corresponding to the data received by the channel device 2 from the IO device 7. If no error occurs after the channel device 2 receives the data from the IO device 7 until the system control device 1 outputs the data to the main storage device 6, the channel device check sum matches with the system control device check sum.

The error detector 29 detects am error if the channel device check sum and the system control device check sum do not match. The error detector 29 notifies the operator of the information processing apparatus that an error has occurred by, for example, making a display on a monitor; however, FIG. 2 does not illustrate any error notification to the operator.

On the data transfer route of the channel device 2, practically, registers (not illustrated) are arranged and each register performs an error check using a parity or ECC check code.

The system control device 1 will be described below. The system control device 1 includes a data input controller 10, a CRC checker 11, a data temporary storage unit 12, a data output controller 13, a check sum calculation unit 14, a check sum transmitter, and a CRC calculation unit 16.

The data input controller 10 receives a packet added with a CRC check code from the data output controller 23 of the channel device 2. The data input controller 10 then outputs the received packet to the CRC checker 11 and then receives the check result from the CRC checker 11.

If no error is detected by the CRC check, the data input controller 10 adds an ECC check code to each set of data and then outputs the data to the data temporary storage unit 12.

The CRC checker 11 receives, from the data input controller 10, an input of the packet that is transmitted from the data output controller 23 to the data input controller 10. The CRC checker 11 then calculates a CRC check code using the data contained in the received packet. The CRC checker 11 then compares the CRC check code added to the received packet and the calculated CRC check code and, if they match, determines that no error has occurred and, if they do not match, detects that an error has occurred.

The CRC checker 11 outputs the CRC check result to the data input controller 10.

When transferring the data to the main storage device 6, the data temporary storage unit 12 temporarily stores the data in order to output the data according to the timing at which the main storage device 6 receives the data. The data temporary storage unit 12 is, for example, a First In, First Out (FIFO) buffer.

The data temporary storage unit 12 receives and stores the data added with the ECC check code from the data input controller 10. The data temporary storage unit 12 sequentially outputs the data according to the timing at which the main storage device 6 receives the data.

The data output controller 13 receives an input of the data to be transmitted to the main storage device 6 from the data temporary storage unit 12. The data output controller 13 detects an error from the received data and ECC and corrects the error. The data output controller 13 proceeds the processing if no error that is not corrected is detected.

The data output controller 13 divides the received data by the cache line size according to the memory access control information that is received from the CPU 5.

The data output controller 13 adds an ECC to the data divided by the cache line size. The data output controller 13 outputs the data added with the ECC to the main storage device 6. The data output controller 13 also outputs the data that is output to the main storage device 6 to the check sum calculation unit 14.

The check sum calculation unit 14 receives, from the data output controller 13, an input of the data that is output to the main storage device 6. The check sum calculation unit 14 acquires, from the data input controller 10, information on the data contained in each packet received from the channel device 2.

The check sum calculation unit 14 calculates, per packet received from the channel device 2, a check sum of the data that is output to the main storage device 6. The check sum calculated by the check sum calculation unit 14 serves as a system control device check sum.

The check sum calculation unit 14 then outputs the calculated system control device check sum to the check sum transmitter 15. The check sum calculation unit 14 serves as an example of a “third calculator”. The system control device check sum serves as an example of “error information per a predetermined unit of transfer”.

The check sum transmitter 15 receives an input of the system control device check sum from the check sum calculation unit 14. The check sum transmitter 15 outputs the received system control device check sum to the CRC calculation unit 16. The check sum transmitter 15 then receives an input of the CRC check code from the CRC calculation unit 16. The check sum transmitter 15 then adds the CRC check code and transmits the system control device check sum to the check sum receiver 26 of the channel device 2.

The CRC calculation unit 16 receives, from the check sum transmitter 15, the system control device check sum to be transmitted to the channel device 2. The CRC calculation unit 16 then calculates a CRC check code on the basis of each system control device check sum. The CRC calculation unit 16 then outputs the calculated CRC check code to the check sum transmitter 15.

On the data transfer route of the system control device 1, practically, registers (not illustrated) are arranged and each register performs an error check using a parity or ECC check code.

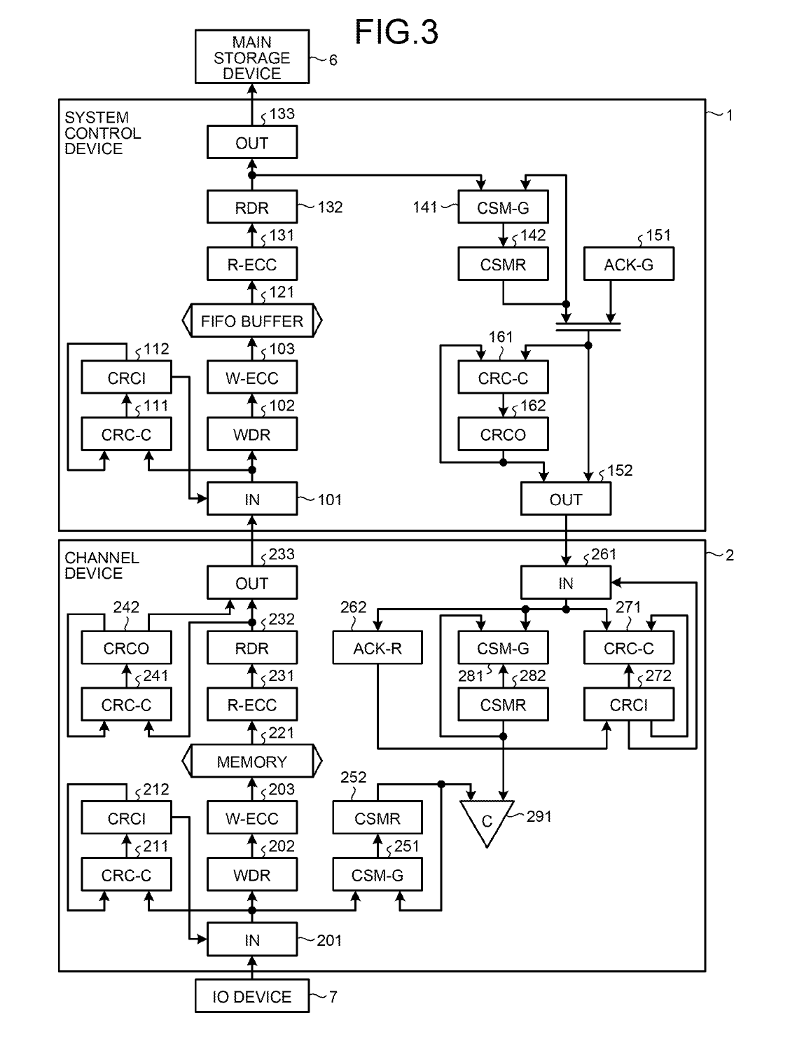

With reference to FIG. 3, the hardware of each unit illustrated in FIG. 2 will be described here. FIG. 3 is a configuration diagram representing an overview of the hardware of the system control device and the channel device.

The channel device 2 will be described first. The data input controller 20 includes an IN 201, a write data register (WDR) 202, and a write-ECC (W-ECC) 203.

The IN 201 is a register that receives a packet from the IO device 7. The IN 201 outputs the packet received from the IO device 7 to a CRC-calculator (CRC-C) 211. If the CRC check code stored in a CRC input register (CRCI) 212 and the CRC check code of the received packet match, the IN 201 outputs the data contained in the received packet to the WDR 202 and a check sum-generator (CSM-G) 251.

The WDR 202 is a register on the data transfer route for writing data in a memory 221. The WDR 202 receives an input of the data from the IN 201. The WDR 202 then outputs the received data to the W-ECC 203.

The W-ECC 203 receives an input of the data from the WDR 202. The W-ECC 203 adds an ECC check code to the received data. The W-ECC 203 then stores the data added with the ECC check code in the memory 221.

The CRC checker 21 includes the CRC-C 211 and the CRCI 212.

The CRC-C 211 receives an input of the packet from the IN 201. The CRC-C 211 then calculates a CRC check code using the data contained in the received packet. More specifically, the CRC-C 211 acquires one set of data contained in the packet, calculates a CRC check code of the data, and stores the check code in the CRCI 212. The CRC-C 211 then acquires another set of data contained in the packet and calculates a CRC check code. Using the calculated CRC check code and the CRC check code stored in the CRCI 212, the CRC-C 211 calculates a CRC check code of a combination of the previous data and the following data. The CRC-C 211 repeats such CRC check code calculation to calculate a CRC check code per word contained in the packet.

The CRCI 212 is a register that stores the CRC check code calculated by the CRC-C 211.

The memory 221 corresponds to the data temporary storage unit 22.

The data output controller 23 includes a read-ECC (R-ECC) 231, a read data register (RDR) 232, and an OUT 233.

The R-ECC 231 reads data from the memory 221. The R-ECC 231 acquires the ECC check code added to the read data and performs an ECC check. If no error is detected, the R-ECC 231 outputs the data to the RDR 232.

The RDR 232 is a data register on the data transfer route for transferring the data read from the memory 221 to the system control device 1. The RDR 232 receives, from the R-RCC 231, an input of the data read from the memory 221. The RDR 232 outputs the received data to a CRC-C 241 and the OUT 233.

The OUT 233 receives an input of the data from the RDR 232. The OUT 233 divides the received data into packets. The OUT 233 also acquires, from a CRC output register (CRCO) 242, a CRC check code to be added to a packet to be transmitted. The OUT 233 then adds the acquired CRC check code to the packet and outputs the packet to the system control device 1.

The CRC calculation unit 24 includes the CRC-C 241 and the CRCO 242.

The CRC-C 241 calculates a CRC check code using the data received from the RDR 232 and stores the CRC check code in the CRCO 242. The CRC-C 241 repeats calculating a CRC check code using the CRC check code stored in the CRCO 242 and the calculated check code to calculate a per-word CRC check code of the packet to be transmitted. The CRC-C 241 stores, in the CRCO 242, the calculated per-word CRC check code of the word to be transmitted.

The check sum calculation unit 25 includes the CSM-G 251 and a check sum register (CSMR) 252.

The CSM-G 251 repeats calculating a channel device check sum by repeating calculating a check sum using the data received from the IN 201 and the already-calculated check sum stored in the CSMR 252 to calculate a channel device check sum. The CSM-G 251 stores the calculated channel device check sum in the CSMR 252.

The CSMR 252 is a register that stores the result of the calculation performed by the CSM-G 251.

The check sum receiver 26 includes an IN 261 and an acknowledge-receiver (ACK-R) 262.

For example, the IN 261 receives a packet containing a system control device check sum and receives an ACK signal from the system control device 1. The IN 261 outputs the ACK to the ACK-R 262. The IN 261 outputs the packet containing the system control device check sum to a CRC-C 271. The IN 261 compares the CRC check code stored in the CRC-C 271 and the CRC check code of the received packet to perform error detection. If no error is detected, the IN 261 outputs the system control device check sum to a CSM-G 281.

Upon receiving the ACK from the IN 261, the ACK-R 262 resets a CRCI 272.

The CRC checker 27 includes the CRC-C 271 and the CRCI 272.

The CRC-C 271 repeats calculating a CRC check code using the data contained in a packet received from the IN 261 and the already calculated CRC check code stored in the CRCI 272. Accordingly, the CRC-C 271 calculates a per-word CRC check code contained in a packet. The CRC-C 271 stores, in the CRCI 272, the calculated per-word CRC check code contained in the packet.

The CRCI 272 is a register that stores the result of the CRC check code calculation performed by the CRC-C 271.

The check sum calculator 28 includes the CSM-G 281 and a CSMR 282.

The CSM-G 281 calculates a system control device check sum by repeating calculating a check sum using the system control device per-packet check sum received from the IN 261 and the already-calculated check sum stored in the CSMR 282. The CSM-G 281 stores the calculated system control device check sum in the CSMR 282.

The CSMR 282 is a register that stores the result of the check sum calculation performed by the CSM-G 281.

A comparator (C) 291 corresponds to the error detector 29. The comparator 291 acquires the channel device check sum from the CSMR 252. The comparator 291 acquires the system control device check sum from the CSMR 282. The comparator 291 compares the channel device check sum and the system controller device check sum to perform error detection.

The data input controller 10 includes an IN 101, a WDR 102, and a W-ECC 103.

The IN 101 is a register that receives a packet from the channel device 2. The IN 101 outputs the packet received from the OUT 233 to a CRC-C 111. If the CRC check code stored in a CRCI 112 and the CRC check code of the received packet match, the IN 101 outputs the data contained in the received packet to the WDR 102.

The WDR 102 is a register on the data transfer route for writing data in an FIFO buffer 121. The WDR 102 receives an input of the data from the IN 101. The WDR 102 outputs the received data to the W-ECC 103.

The W-ECC 103 receives an input of the data from the WDR 102. The W-ECC 103 adds an ECC check code to the received data. The W-ECC 103 stores the data added with the ECC check code in the FIFO buffer 121.

The CRC checker 11 includes the CRC-C 111 and a CRCI 1112.

The CRC-C 111 repeats calculating a CRC check code using the data contained in the packet received from the IN 101 and the already-calculated CRC check code stored in the CRCI 112. Accordingly, the CRC-C 111 calculates a per-word CRC check code contained in the packet. The CRC-C 111 stores, in the CRCI 112, the calculated per-word CRC check code contained in the packet.

The CRCI 112 is a register that stores the result of the CRC check code calculation performed by the CRC-C 111.

The FIFO buffer 121 corresponds to the data temporary storage unit 12.

The data output controller 13 includes an R-ECC 131, an RDR 132, and an OUT 133.

The R-ECC 131 reads data from the FIFO buffer 121. The R-ECC 131 acquires the ECC check code added to the read data and check the ECC. If no error is detected, the R-ECC 131 outputs the data to the RDR 132.

The RDR 132 is a data register on the data transfer route for transferring the data read from the FIFO buffer 121 to the main storage device 6. The RDR 132 receives, from the R-ECC 131, an input of the data read from the FIFO buffer 121. The RDR 132 then outputs the received data to the OUT 133 and a CSM-G 141.

The OUT 133 receives an input of the data from the RDR 132. The OUT 133 divides the received data by the cache line size. The OUT 133 then adds an ECC check code to the divided data and outputs the data added with the ECC check code to the main storage device 6.

The check sum calculation unit 14 includes the CSM-G 141 and a CSMR 142.

The CSM-G 141 calculates a system control device per-packet check sum by repeating calculating a check sum using the data received from the RDR 132 and the already-calculated check sum stored in the CSMR 142. The CSM-G 141 stores the calculated system control device per-packet check sum in the CSMR 142.

The CSMR 142 is a register that stores the result of the check sum calculation performed by the CSM-G 141.

The check sum transmitter 15 includes an ACK-generator (ACK-G) 151 and an OUT 152.

Once calculation of a check sum of one packet transmitted by the channel device 2 ends and the system control device per-packet check sum is stored in the CSMR 142, the ACK-G 151 transmits an ACK reply instruction to the OUT 152. Until calculation of system control device per-packet check sums corresponding to the all data transmitted from the channel device 2 ends, the ACK-G 151 issues a reply instruction notification each time a system control device per-packet check sum is stored.

Upon receiving the ACK reply instruction notification, the OUT 152 outputs the packet header that is the ACK to the IN 261.

The OUT 152 then acquires the system control device per-packet check sum from the CSMR 142. The OUT 152 also acquires, from a CRCO 162, a CRC check code to be added to the packet containing the system control device per-packet check sum. The OUT 152 then adds the CRC check code to the packet containing the system control device per-packet check sum and transmits the packet added with the CRC check code to the IN 261.

The CRC calculation unit 16 includes a CRC-C 161 and the CRCO 162.

Once the ACK reply instruction is transmitted from the ACK-G 151, the CRC-C 161 acquires the system control device per-packet check sum from the CSMR 142. Using the acquired system control device per-packet check sum, the CRC-C 161 calculates the CRC check code of the system control device per-packet check sum. The CRC-C 161 stores, in the CRCO 162, the calculated CRC check code of the system control device per-packet check sum.

The CRCO 162 is a register that stores the result of the CRC check sum calculation performed by the CRC-C 161.

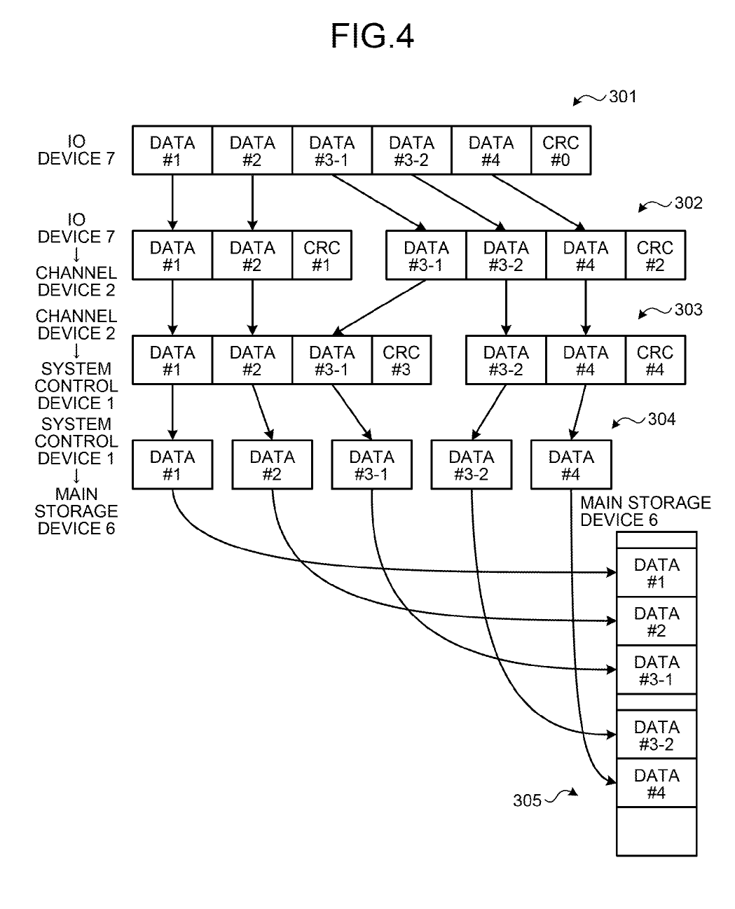

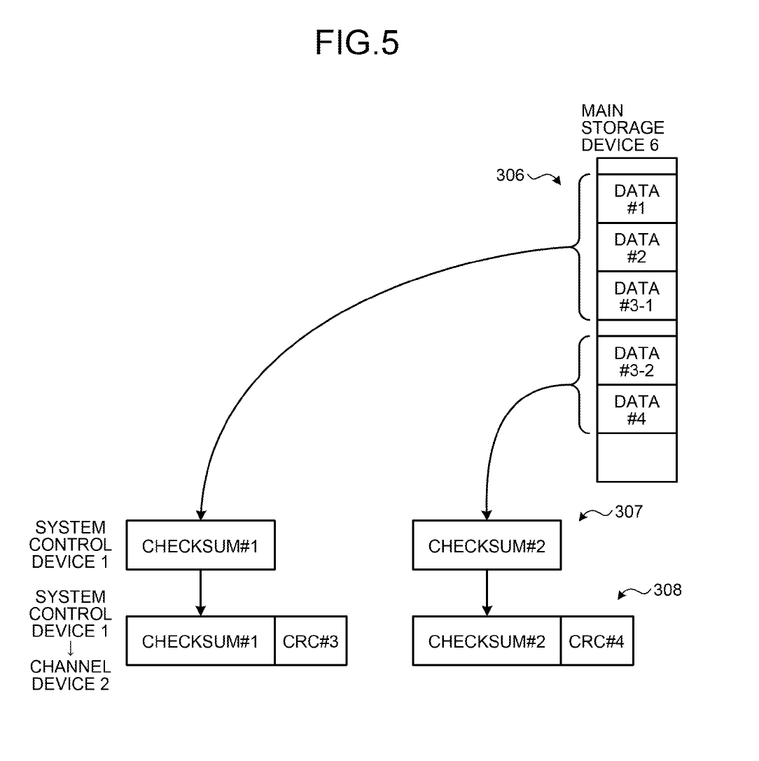

The processing performed by each unit and the state of data that is transferred will be specifically described using an exemplary case where Data#1, Data#2, Data#3-1, Data#3-2, and Data#4 are transferred from the IO device 7 to the main storage device 6. First, using FIGS. 4 and 5, the state of data division in this case will be described. FIG. 4 illustrates exemplary division of data to be transmitted from the IO device to the main storage device. FIG. 5 illustrates exemplary division of a system control device per-packet check sum to be transmitted from the system control device to the channel device.

The state 301 illustrated in FIG. 4 illustrates a state where Data#1 to Data#4 are stored in the IO device 7. Data#1 to Data#4 being stored in the IO device are a data group that is one unit of processing and that is collectively added with CRC#0 that is a check code. In other words, Data#1 to Data#4 are the whole data of the data transmission.

The state 302 illustrates a state where Data#1 to Data#4 are transmitted from the IO device 7 to the channel device 2. The IO device 7 divides the data into packets, i.e., generates a packet containing Data#1 and Data#2 and a packet containing Data#3-1, Data#3-2, and Data#4. The IO device 7 adds CRC#1 that is a CRC check code to the packet containing Data#1 and Data#2 and outputs the packet added with CRC#1 to the channel device 2. The IO device 7 adds CRC#2 that is a CRC check code to the packet containing Data#3-1, Data#3-2, and Data#4 and outputs the packet added with CRC#2 to the channel device 2.

The state 303 illustrates a state where Data#1 to Data#4 are transmitted from the channel device 2 to the system control device 1. The channel device 2 divides the data into packets for data communications between the channel device 2 and the system control device 1. In this case, the channel device 2 generates a packet containing Data#1, Data#2, and Data#3-1 and a packet containing Data#3-2 and Data#4. The channel device 2 adds CRC#3 that is a CRC check code to the packet containing Data#1, Data#2, and Data#3-1 and outputs the packet added with CRC#3 to the system control device 1. The channel device 2 also adds CRC#4 that is a CRC check code to the packet containing Data#3-2 and Data#4 and outputs the packet added with CRC#4 to the system control device 1.

The state 304 illustrates a state where Data#1 to Data#4 are transmitted from the system control device 1 to the main storage device 6. The system control device 1 divides the data by the cache line size. In this case, the system control device 1 separates Data#1 to Data#4 from one another. The system control device 1 then outputs Data#1 to Data#4, which are separated from one another, to the main storage device 6.

The state 305 illustrates a state where Data#1 to Data#4 are stored in the main storage device 6. Data#1 to Data#4 are divided per cache line and stored in the main storage device 6.

The state 306 illustrated in FIG. 5 illustrates the state where Data#1 to Data#4 are stored in the main storage device 6, i.e., the same state as the state 305 illustrated in FIG. 4.

The state 307 illustrates a state where the system control device per-packet check sum that is calculated by the system control device 1. Here, practically, the system control device 1 calculates a check sum using the same data as the data transmitted to the main storage device 6. Note that FIG. 5 illustrates arrows that associate the data of the main storage device 6 and the check sums in order for easy understanding of which set of data is associated with which check sum. The system control device 1 calculates a check sum for data of one packet equivalent to the packet that is transmitted by the channel device 2. Here, the system control device 1 calculates CheckSum#1 as a system control device per-packet check sum of the packet containing Data#1, Data#2, and Data#3-1. The system control device 1 also calculates CheckSum#2 as a system control device per-packet check sum of the packet containing Data#3-2 and Data#4.

The state 308 illustrates a state where the system control device per-packet check sum is transmitted from the system control device 1 to the main storage device 6. The system control device 1 adds, to CheckSum#1, CRC#3 that is a CRC check code that is calculated from CheckSum#1 and transmits CheckSum#1 added with CRC#3 to the channel device 2. The system control device 1 also adds, to CheckSum#2, CRC#34 that is a CRC check code that is calculated from CheckSum#2 and transmits CheckSum#2 added with CRC#4 to the channel device 2.

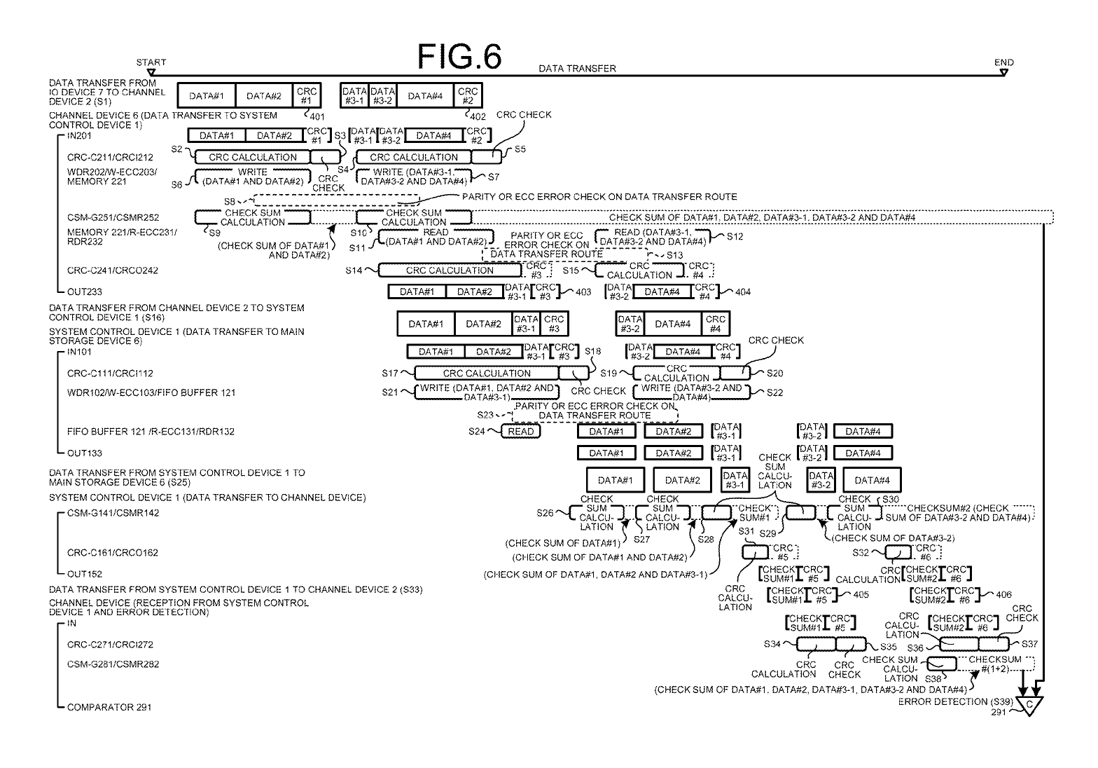

A series of operations performed by each unit to perform the above-described data transfer will be described collectively with reference to FIG. 6. FIG. 6 is a timing chart of operations performed by each unit to perform the data transfer. The boxes in dotted lines illustrated in FIG. 6 represent calculation results. The boxes in dashed lines illustrated in FIG. 6 represent error detection processing performed on the route other than the processing performed by each unit. FIG. 6 illustrates operations of each of the units illustrated on the left end and the state of data transferred.

The IO device 7 transmits packets 401 and 402 to the channel device 2 to perform data transfer (step S101). The IN 201 receives the packet 401, i.e., Data#1, Data#2 and CRC#1. The IN 201 then receives the packet 402, i.e., the Data#3-1, Data#3-2, Data#4 and CRC#2.

The CRC-C 211 and the CRCI 212 performs CRC calculation from Data#1 and Data#2 to calculate a CRC check code (step S2). The CRC-C 211 and the CRCI 212 then performs a CRC check, i.e., performs error detection using a CRC (step S3). The CRC-C 211 and the CRCI 212 perform a CRC calculation from the Data#3-1, Data#3-2, and Data#4 contained in the packet 402 to calculate a CRC check code (step S4). The CRC-C 211 and the CRCI 212 then perform a CRC check (step S5).

The WDR 202 and the W-ECC 203 write Data#1 and Data#2 in the memory 221 (step S6). The WDR 202 and the W-ECC 203 then write the Data#3-1, Data#3-2 and Data#4 in the memory 221 (step S7).

On the data transfer route, each set of data undergoes a parity or ECC check (step S8).

The CSM-G 251 calculates a check sum using Data#1 and Data#2 (step S9). The calculated check sum of Data#1 and Data#2 is stored in the CSMR 252. Furthermore, the CSM-G251 calculates a check sum of Data#1 to Data#4 using Data#3-1, Data#3-2 and Data#4 and Data#1 and Data#2 stored in the CSMR 252 (step S10). The calculated check sum of Data#1 to Data#4, i.e., the channel device check sum, is stored in the CSMR 252.

The R-ECC 231 and the RDR 232 read Data#1 and Data#2 from the memory 221 (step S11). The R-ECC 231 and the RDR 232 read Data#3-1, Data#3-2 and Data#4 from the memory 221 (step S12).

Furthermore, on the data transfer route, each set of data undergoes a parity or ECC check (step S13).

The CRC-C 241 performs a CRC calculation for the data of a unique packet length used to communicate data between the channel device 2 and the system control device 1. Here, the CRC-C 241 performs, as a CRC calculation for the first packet, a CRC calculation for the packet containing Data#1, Data#2, and Data#3-1 (step S14). The CRC-C 241 stores CRC#3 that is a calculated CRC check code in the CRCO 242. The CRC-C 241 then performs, as a CRC calculation of the next packet, a CRC calculation for the packet containing Data#3-2 and Data#4 (step S15). The CRC-C 241 stores CRC#4 that is a calculated CRC check code in the CRCO 242.

The OUT 233 transmits a packet 403 where Data#1, Data#2, and Data#3-1 are added with CRC#3 to the IN 101 of the system control device 1. The OUT 233 transmits a packet 404 where Data#3-2 and Data#4 are added with CRC#4 to the IN 101 of the system control device 1. In the manner, data transfer from the channel device 2 to the system control device 1 is performed (step S16). The IN 101 receives the packet 403, i.e., Data#2, Data#2-1, and CRC#3. The IN 101 then receives the packet 404, i.e., Data#3-2, Data#4, and CRC#4.

The CRC-C 111 and the CRCI 112 perform a CRC calculation from Data#1, Data#2, and Data#3-1 contained in the packet 403 to calculate a CRC check code (step S17). The CRC-C 111 and the CRCI 112 then perform a CRC check (step S18). The CRC-C 111 and the CRCI 112 perform a CRC calculation from Data#3-2 and Data#4 contained in the packet 404 to calculate a CRC check code (step S19). The CRC-C 111 and the CRCI 112 then perform a CRC check (step S20).

The WDR 102 and the W-ECC 103 write Data#1, Data#2, and Data#3-1 in the FIFO buffer 121 (step S21). The WDR 102 and the W-ECC 103 write Data#3-2 and Data#4 in the FIFO buffer 121 (step S22).

On the data transfer route, each set of data undergoes a party or ECC check (step S23).

The R-ECC 131 and the RDR 132 read Data#1 to Data#4 from the FIFO buffer 121 (step S24).

The OUT 133 transmits Data#1 to Data#4 that are divided by the cache line size to the main storage device 6 so that data transfer from the system control device 1 to the main storage device 6 is performed (step S25).

The CSM-G 141 acquires the data that is transmitted from the RDR 132 to the OUT 133. The CSM-G 141 calculates a check sum of Data#1 from Data#1 (step S26). The CSM-G 141 stores the check sum of the Data#1 in the CSMR 142. The CSM-G 141 then calculates a check sum of Data#1 and Data#2 using Data#1 and the check sum of Data#1 stored in the CSMR 142 (step S27). The CSM-G 141 stores the check sum of Data#1 and Data#2 in the CSMR 142. Using Data#3-1 and the check sum of Data#1 and Data#2 stored in the CSMR 142, the CSM-G 141 then calculates CheckSum#1 that is a check sum of Data#1, Data#2, and Data#3-1 (step S28). The CSM-G 141 stores CheckSum#1 in the the CSMR 142.

The CSM-G 141 calculates a check sum of Data#3-2 from Data#3-2 (step S29). The CSM-G 141 stores the check sum of Data#3-2 in the CSMR 142. The CSM-G 141 then calculates CheckSum#2 that is a check sum of Data#3-2 and Data#4 using Data#4 and the check sum of Data#3-2 stored in the CSMR 142 (step S30). The CSM-G 141 stores CheckSum#2 in the CSMR 142.

The CRC-C 161 performs a CRC calculation using CheckSum#1 (step S31). The CRC-C 161 stores CRC#5 that is a calculated CRC check code in the CRCO 162. The CRC-C161 then performs a CRC calculation using CheckSum#2 (step S32). The CRC-C161 stores CRC#6 that is a calculated CRC check code in the CRCO 162.

The OUT 152 transmits a packet where CRC#5 is added to CheckSum#1 to the IN 261 of the channel device 2. The OUT 152 transmits a packet where CRC#6 is added to CheckSum#2 to the IN 261. Accordingly, data transfer from the system control device 1 to the channel device 2 is performed (step S33). The IN 261 receives a packet 405, i.e., CheckSum#1 and CRC#5. The IN 261 then receives a packet 406, i.e., CheckSum#2 and CRC#6.

The CRC-C 271 and the CRCI 272 perform a CRC calculation from CheckSum#1 contained in the packet 405 to calculate a CRC check code (step S34). The CRC-C 271 and the CRCI 272 perform a CRC check (step S35). A CRC-C 171 and a CRCI 172 then perform a CRC calculation from CheckSum#2 contained in the packet 406 to calculate a CRC check code (step S36). The CRC-C 271 and the CRCI 272 then perform a CRC check (step S37).

The CSM-G 281 calculates a check sum of the whole Data#1 to Data#4, i.e., a system control device check sum, using the CheckSum#1 and CheckSum#2 (step S38).

The comparator 291 performs error detection by comparing the system control device check sum and the channel device check sum (step S39).

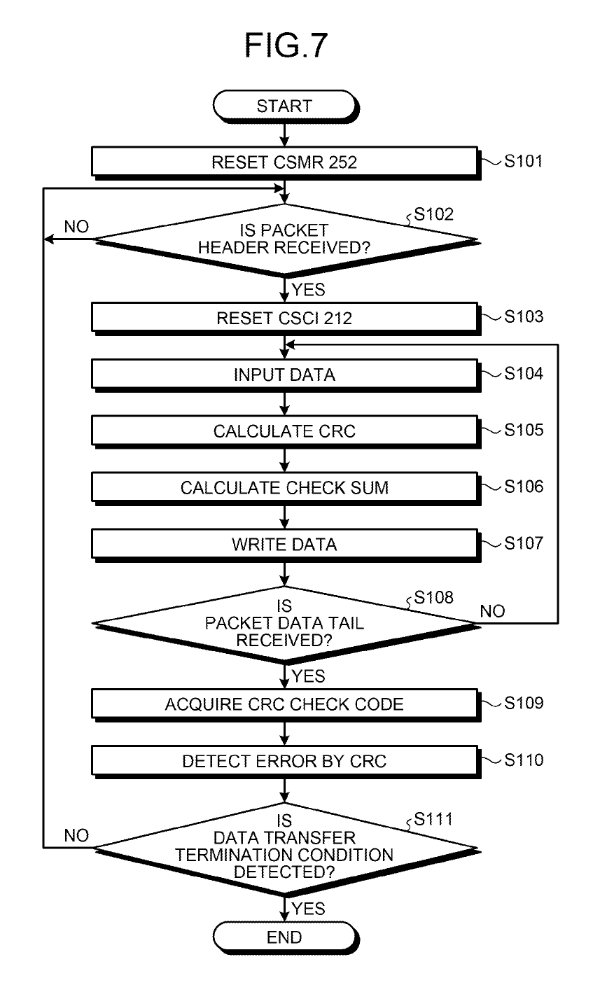

Operations performed by the channel device 2 to receive data from the IO device 7 will be described with reference to FIG. 7 here. FIG. 7 is a flowchart of operations performed by the channel device to receive data from an IO device.

Once inputting of data from the IO device 7 to the IN 201 is started, the data input controller 20 resets the CSMR 252 that is the register of the check sum calculation unit 25 that stores the result of check sum calculation from the data received from the IO device 7 (step S101).

The data input controller 20 determines whether a header of a packet (hereinafter, “packet header”) is received (step S102). If no packet header is received (NO at step S102), the data input controller 20 waits until a packet header is received.

On the other hand, if a packet header is received (YES at step S102), the data input controller 20 resets the CRCI 212 that is the register of the CRC checker 21 that stores the CRC check result per packet (step S103).

The data input controller 20 receives an input of the data from the IO device 7 (step S104).

The CRC checker 21 performs a CRC calculation from the input data to calculate a CRC check code (step S105).

The check sum calculation unit 25 calculates a check sum of the input data (step S106).

The data input controller 20 writes the input data in the data temporary storage unit 22 (step S107).

The data input controller 20 determines whether a packet data tail is received (step S108). If no tail is received (NO at step S108), the data input controller 20 returns to step S104. In other words, the data input controller 20 repeats the processing until data of one packet is received.

On the other hand, if a packet data tail is received (YES at step S108), the data input controller 20 acquires a CRC check code from the received data (step S109). The data input controller 20 performs error detection by using CRC by comparing the packet CRC check code stored in the CRCI 212 and the acquired CRC check code (step S110).

The data input controller 20 determines whether a data transfer termination condition is detected (step S111). A data transfer termination condition is, for example, reception of a data transfer termination notification from the IO device 7. If no data transfer termination condition is detected (NO at step S111), the data input controller 20 returns to step S102.

On the other hand, if a data transfer termination condition is detected (YES at step S111), the data input controller 20 terminates the data receiving processing.

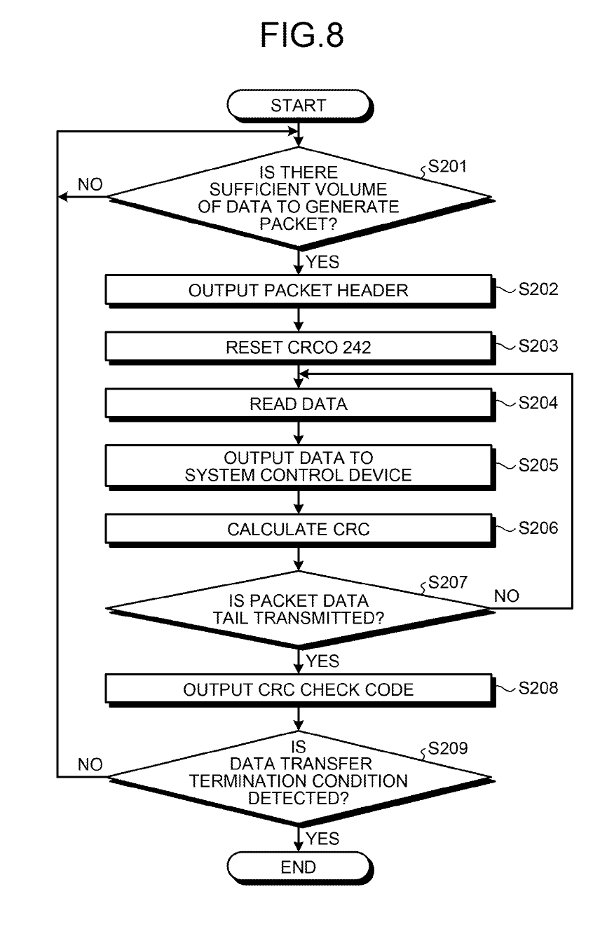

Operations performed by the channel device 2 to transmit data to the system control device 1 will be described below with reference to FIG. 8. FIG. 8 is a flowchart of operations performed by the channel device to transmit data to the system control device.

Once the data transfer is started, the data output controller 23 monitors the data temporary storage unit 22 and determines whether there is a sufficient volume of data to generate a packet in the data temporary storage unit 22 (step S201). If there is not a sufficient volume of data to generate a packet (NO at step S201), the data output controller 23 waits until the data accumulates to a sufficient volume to generate a packet in the data temporary storage unit 22.

On the other hand, if there is a sufficient volume of data to generate a packet (YES at step S201), the data output controller 23 outputs the packet header to the system control device 1 (step S202).

The data output controller 23 resets the CRCO 242 that is the register of the CRC calculation unit 24 that stores a CRC check code per packet (step S203).

The data output controller 23 then reads the data from the data temporary storage unit 22 (step S204).

The data output controller 23 performs an ECC check on the read data, adds a parity to the data and outputs the data added with the parity to the system control device 1 (step S205). For example, the data output controller 23 sets the data added with the parity in the RDR 232 illustrated in FIG. 3, adjusts the timing, sets the data in the OUT 233, and transfers the data to the system control device 1.

The CRC calculation unit 24 performs a CRC calculation for the data read by the data output controller 23 and stores the calculation result in the CRCO 242 (step S206).

The data output controller 23 determines whether a packet data tail is transmitted (step S207). If a packet data tail is not transmitted (NO at step S207), the data output controller 23 returns to step S204. In other words, the data output controller 23 repeats the processing until data of one packet is transmitted.

If a packet data tail is transmitted (YES at step S207), the data output controller 23 outputs the CRC check code calculated by the CRC calculation unit 24 to the system control device 1 (step S208).

The data output controller 23 then determines whether a data transfer termination condition is detected (step S209). A data transfer termination condition is, for example, transmission of data with a flag indicating that this is the last data. If no data transfer termination condition is detected (NO at step S209), the data output controller 23 returns to step S201.

On the other hand, if a data transfer termination condition is detected (YES at step S209), the data output controller 23 terminates the data transmission processing.

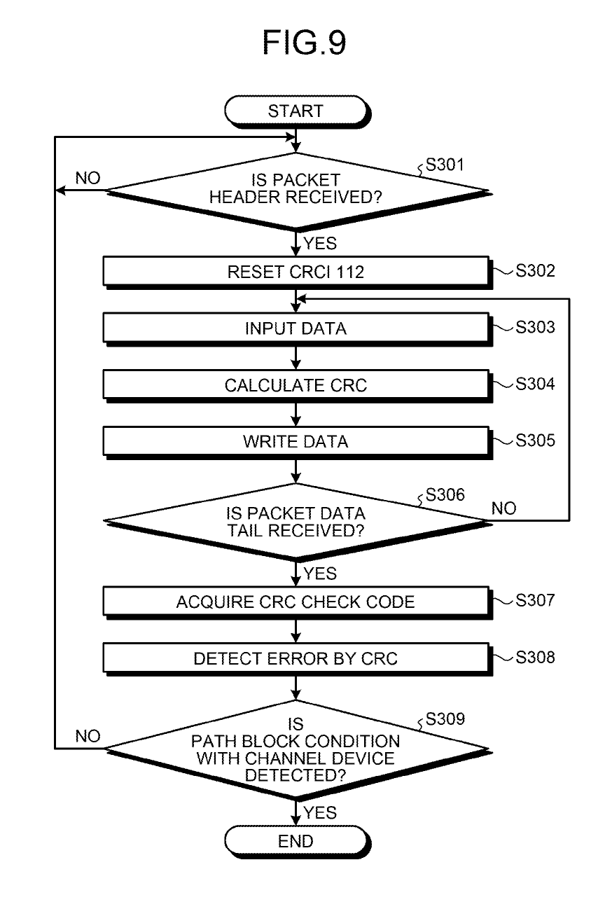

Operations performed by the system control device 1 to receive data from the channel device 2 will be described below with reference to FIG. 9. FIG. 9 is a flowchart of operations performed by the system control device to receive data from the channel device.

The data input controller 10 determines whether a packet header is received (step S301). If no packet header is received (NO at step S301), the data input controller 10 waits until a packet header is received.

On the other hand, if a packet header is received (YES at step S301), the data input controller 10 resets the CRCI 112 that is the register of the CRC checker 11 that stores the CRC check result per packet (step S302).

The data input controller 10 receives an input of the data from the channel device 2 (step S303).

The CRC checker 11 performs a CRC calculation from the input data to calculate a CRC check code (step S304).

The data input controller 10 writes the input data in the data temporary storage unit 12 (step S305).

The data input controller 10 determines whether a packet data tail is received (step S306). If no packet data tail is received (NO at step S306), the data input controller 20 returns to step S303. In other words, the data input controller 10 repeats the processing until data of one packet is received.

On the other hand, if a packet data tail is received (YES at step S306), the data input controller 10 acquires the CRC check code from the received data (step S307). The data input controller 10 performs error detection using CRC by comparing the packet CRC check code stored in the CRCI 112 and the acquired CRC check code (step S308).

The data input controller 10 determines whether a path block condition with the channel device 2 is detected (step S309). A path block condition is, for example, a channel disconnection from the channel device 2 in an off-line setting. If no path block condition is detected (NO at step S309), the data input controller 10 returns to step S301.

On the other hand, if a path block condition is detected (YES at step S309), the data input controller 10 terminates the data reception processing.

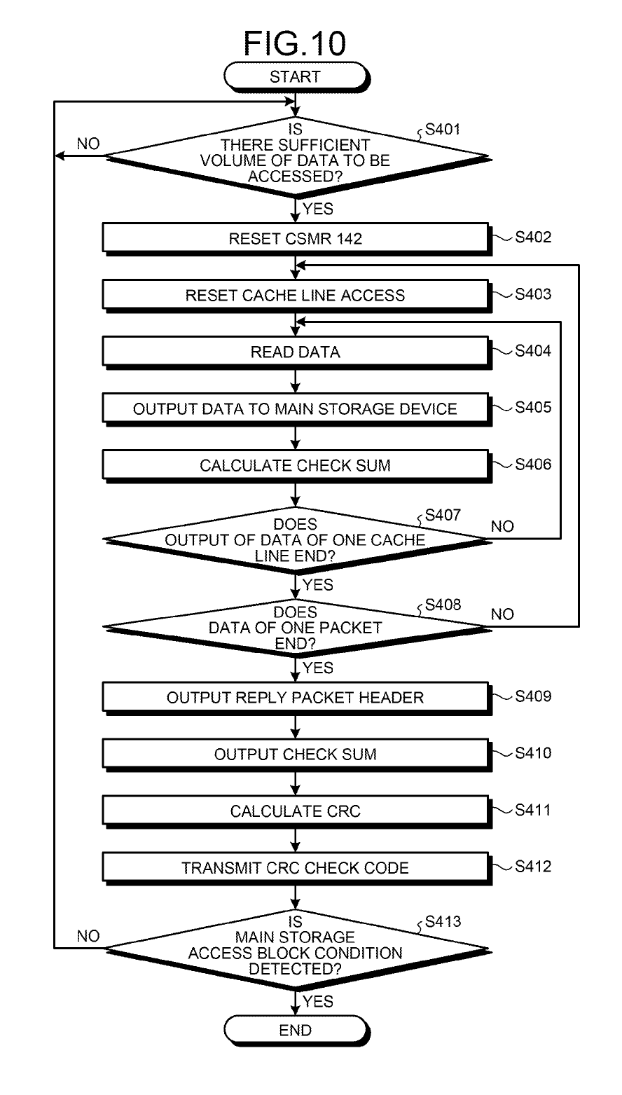

Operations performed by the system control device 1 to transmit data to the channel device 2 will be described with reference to FIG. 10. FIG. 10 is a flowchart of operations performed by the system control device to transmit data to the channel device.

The data output controller 13 monitors the data temporary storage unit 12 and determines whether, in the data temporary storage unit 12, there is a sufficient volume of data to be accessed, i.e., a volume of data of one packet received from the channel device 2 (step S401). If there is not a sufficient volume of data to be accessed (NO at step S401), the data output controller 13 waits until the data accumulates to a sufficient volume of data to be accessed in the data temporary storage unit 12.

On the other hand, if there is a sufficient volume of data to be accessed (YES at step S401), the data output controller 13 performs the following processing. The data output controller 13 resets the CSMR 142 that is the register of the check sum calculation unit 14 for storing the result of check sum calculation from the data read from the data temporary storage unit 12 (step S402).

The the data output controller 13 performs resetting in order to divide the data by the cache line size and stores the divided data in the main storage device 6 (step S403).

The the data output controller 13 then reads the data from the data temporary storage unit 12 (step S404). The data output controller 13 performs an ECC check on the read data, then adds an ECC again, and outputs the data added with the ECC to the main storage device 6 (step S405). For example, the data output controller 13 sets the data added with the ECC in the RDR 132 illustrated in FIG. 3, adjusts the timing, sets the data in the OUT 133, and transfers the data to the main storage device 6.

The check sum calculation unit 14 calculate a check sum of the data output by the data output controller 13 to the main storage device 6 and sets the calculated check sum in the CSMR 142 (step S406).

The data output controller 13 determines whether an output of data of one cache line ends (step S407). If an output of data of one cache line does not end (NO at step S407), the data output controller 13 returns to step S404.

If an output of data of one cache line ends (YES at step S407), the data output controller 13 determines whether an output of data of one packet ends (step S408). If an output of data of one packet does not end (NO at step S408), the data output controller 13 returns to step S403.

If an output of data of one packet ends (YES at step S408), the data output controller 13 outputs a reply packet header that is an ACK to the channel device 2 (step S409).

The check sum transmitter 15 acquires the check sum of one packet that is stored in the check sum calculation unit 14 and outputs the check sum to the channel device 2 (step S410).

The CRC calculation unit 16 performs a CRC calculation from the data transmitted by the check sum transmitter 15 and stores the calculation result in the CRCO 162 (step S411).

The check sum transmitter 15 transmits the CRC check code calculated by the CRC calculation unit 16 to the channel device 2 (step S412).

The data output controller 13 then determines whether a main storage access block condition is detected (step S413). A main storage access block condition is, for example, a path connection between the main storage device 6 and the system control device 1 due to, for example, a configuration change. If no main storage access block condition is detected (No at step S413), the data output controller 13 returns to step S401.

On the other hand, if a main storage access block condition is detected (YES at step S413), the data output controller 13 terminates the data transmission processing.

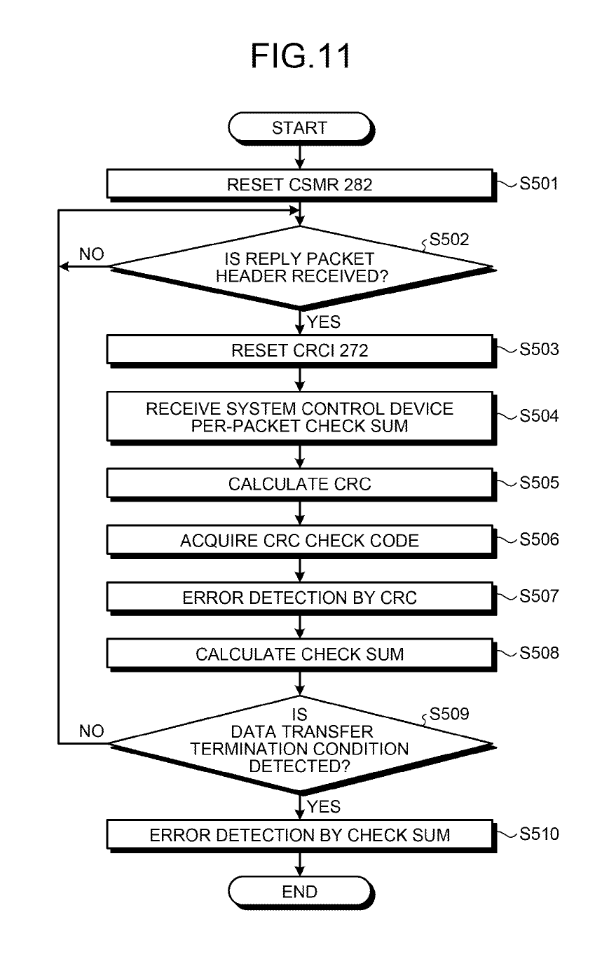

Operations performed by the channel device 2 to receive a check sum from the system control device 1 will be described below with reference to FIG. 11. FIG. 11 is a flowchart of operations performed by the channel device to receive a check sum from the system control device.

The check sum receiver 26 rests the CSMR 282 that is a register of the check sum calculator 28 for adding a check sum received from the system control device 1 (step S501).

The check sum receiver 26 determines whether a reply packet header is received (step S502). If no packet header is received (NO at step S502), the check sum receiver 26 waits until a packet header is received.

On the other hand, if a packet header is received (YES at step S502), the check sum receiver 26 resets the CRCI 272 that is the register of the CRC checker 27 for storing a CRC check code per packet (step S503).

The check sum receiver 26 receives a system control device per-packet check sum from the system control device 1 (step S504).

The CRC checker 27 performs a CRC calculation from the system control device per-packet check sum, which is input, and stores the calculated CRC check code in the CRCI 272 (step S505).

The check sum receiver 26 also acquires the CRC check code added to the system control device per-packet check sum (step S506).

The check sum receiver 26 performs error detection using CRC by comparing the packet CRC check code stored in the CRCI 172 and the acquired CRC check code (step S507).

The check sum receiver 26 then outputs the received system control device per-packet check sum to the check sum calculator 28. The check sum calculator 28 calculates a check sum using the received system control device per-packet check sum (step S508). Specifically, the check sum calculator 28 sums system control device per-packet check sums.

The check sum receiver 26 determines whether a data transfer termination condition is detected (step S509). A data transfer termination condition is, for example, reception of a data transfer termination notification from the system control device 1. If no data transfer termination condition is detected (NO step S509), the check sum receiver 26 returns to step S502.

On the other hand, if a data transfer termination condition is detected (YES at step S509), the check sum calculator 28 performs error detection by comparing the system control device check sum and the channel device check sum (step S510).

In the information processing apparatus according to the embodiment, in transfer of data that is relayed by the channel device and the system control device, an error check is performed using the check sum on the data received by the channel device and the signal sent by the system control device. Accordingly, an error that is difficult to detect due to a parity or ECC error can be detected during data transfer between the channel device and the system control device. Furthermore, because the channel device performs error detection using a check sum, data transfer can be performed without addition of check sum, which prevents the transfer efficiency from lowering. In other words, the information processing apparatus according to the embodiment can perform accurate error detection at high transfer efficiency.

If the system control device performs a check, because the check is performed before data is stored in a storage unit, such as an FIFO for storing data, there is a section where error detection is not performed, i.e., an insecure section, on the data transfer route. In this respect, in the information processing apparatus according to the embodiment, because the channel device performs error detection using a check sum, the data externally sent by the system control device can be used for the error detection, which enables and ensures error detection everywhere on the data transfer route.

According to one aspect of the information processing apparatus, the information processing system, and a failure detection method method disclosed herein, an information processing apparatus, an information processing system, and a failure detection method for performing secure error detection at high transfer efficiency can be provided.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus comprising:
a first transfer unit that receives data and transfers the data to a second transfer unit per a predetermined unit of transfer; and
the second transfer unit that sends the data that is received from the first transfer unit,
wherein the first transfer unit includes:
a first calculator that calculates first error information on the whole received data on the basis of the received data;
a second calculator that calculates, on the basis of the data that is sent by the second transfer unit, second error information on the whole sent data; and
an error detector that compares the first error information and the second error information to detect an error.

2. The information processing apparatus according to claim 1, wherein
the second transfer unit further includes a third calculator that calculates, per the predetermined unit of transfer, error information on the sent data and transmits the error information to the first transfer unit and
the second calculator calculates the second error information on the basis of the error information per the predetermined unit of transfer that is received from the third calculator.

3. The information processing apparatus according to claim 1, wherein
the first calculator acquires a check sum of the whole received data as the first error information, and
the second calculation unit acquires, as the second error information, a check sum of the whole data sent from the second transfer unit.

4. An information processing system comprising:
a first data transfer device; and
a second data transfer device,
the first transfer device including:
a receiver that receives data;
a first transfer unit that transmits, per a predetermined unit of transfer, the data received by the receiver to the second data transfer device;
a first calculator that calculates, on the basis of the data received by the receiver, first error information on the whole received data;
a second calculator that calculates, on the basis of the data that is sent by the second data transfer device, second error information on the whole sent data; and
an error detector that compares the first error information and the second error information to detect an error, and
the second data transfer device including:
a second transfer unit that sends the data received from the first data transfer device.

5. A failure detection method comprising:
receiving data and transfer the data to a second data transfer device per a predetermined unit of transfer by a first data transfer device;
calculating first error information on the whole received data on the basis of the received data by the first data transfer device;
sending the data received from the first data transfer device by the second data transfer device;
calculating, on the basis of the data sent by the second data transfer device, second error information on the whole sent data by the first data transfer device; and
comparing the first error information and the second error information to detect an error by the first data transfer device.
